(19) United States
(12) Patent Application Publication
(10) Pub. No.: US 2006/0005073 A1
(43) Pub. Date: Jan. 5, 2006

(54) Data integrity checking in data storage devices

(76) Inventors: John M. Clifton, Hertford (GB); Daniel C. Rumney, Winchester (GB); Jonathan I. Settle, Winchester (GB)

Correspondence Address: LIEBERMAN & BRANDSDORFER, LLC, 802 STILL CREEK LANE, GAITHERSBURG, MD, 20878, US

(21) Appl. No.: 11/170,359

(22) Filed: Jun. 29, 2005

(30) Foreign Application Priority Data
Jun. 30, 2004 (GB) 0414622.1

(51) Int. Cl. G06F 12/16

(52) U.S. Cl. 714/5; 711/203; 711/144

(57) ABSTRACT

A method for operating a data storage device having a data storage medium partitioned into blocks comprises. A binary value is assigned to each block, with the initial setting of each binary value to a first level. Subsequently the binary value assigned to each block into which data is written is set to the second level. In response to a request from a host to read data from a block, the binary value assigned to the block checked, and data from the block is read if the assigned binary value is set to the second level. An algorithm is executed to generate the data if the assigned binary value is set to the first level. The read data or the algorithm generated data is sent to the host.

### FIELD OF THE INVENTION

The present invention relates to data integrity checking data storage devices.

### BACKGROUND OF THE INVENTION

A data processing system typically comprises a host computer system connected to a storage device via a storage controller. The storage device typically comprises a storage medium such as a magnetic data storage disk. The storage medium is typically formatted during an initialisation routine in preparation for storage of user data. The formatting typically includes partitioning of the storage medium into blocks or logical block addresses (LBAs). Each LBA includes a portion for storage of data and a portion for storage of error checking and correction (ECC) codes associated with the data. The ECC codes are typically generated based on the data by an integrity checking algorithm. Such initialisation can be time consuming, particularly in systems having multiple storage devices.

Data sent for the host for storage by the storage device is typically checked for errors by the controller and corrected where necessary. However, errors may be introduced in data communications between the controller and the storage device. Such errors, which can remain undetected for some time after the corrupted data is written to the storage medium, may affect both user data to be recorded during user sessions running on the host and initialisation data to be recorded during initialisation of the storage device.

During normal operation, the host will typically read only from LBAs on the storage medium that have user data written into them. However, when for example recovering from failure, the controller will read from all LBAs on the storage medium irrespective of whether the data recorded in each LBA has changed since initial configuration. It will be appreciated that this is a time consuming activity.

It would be desirable to provide improved methods and apparatus for integrity checking in data processing systems.

### SUMMARY OF THE INVENTION

In one aspect of the invention, a method is provided for operating a data storage device with a data storage medium partitioned into blocks. A binary value is assigned to each block, and an initial binary value for each block is set to a first level. The binary value is set to a second level when the individual block is in receipt of written data. A host may send a request to read data from the block which would support receipt of a response from the data storage device. The response includes checking the binary value assigned to the block, and generating read data from the block is the binary value of the block is set to the second level. However, if the binary value of the block is set to the first level, response data is generated. Following the generation of read data or response data, the data is sent to the host in the form of read data or response data.

In another aspect of the invention, a data storage device is provided with a data storage medium partitioned into blocks. Logic is provided to assign a binary value to each block. The binary value is initially set to a first level and is set to a second level in response to receipt of written data. An algorithm is provided within the storage device to respond to a request from a host to read data from the block. The algorithm checks the binary value assigned to the block and reads data from the block if the binary is set to the second level. If the binary is not set to the second level, the algorithm generates response data. Following the step of reading data from the block or generating response data, the algorithm forwards the data to the host. The forwarded data may be read data or response data.

In yet another aspect of the invention, a computer program product is provided with a computer readable medium embodying a computer useable program code for operating a data storage medium partitioned into blocks. The product includes program code to assign a binary value to each block in the data storage medium. The initial binary value of each block is set to a first level. The binary is set to the second level at such time as the associated block is in receipt of written data. The product also includes program code to respond to a request from a host to read data from the block. The code includes instructions to check the binary value assigned to the block, instructions to generate read data from the block if the binary value is set to the second level, instructions to execute an algorithm to generate response data if the binary value if the block is set to the first level, and instructions to send data to the host. The data sent to the host includes read data or response data.

Other features and advantages of this invention will become apparent from the following detailed description of the presently preferred embodiment of the invention, taken in conjunction with the accompanying drawings.

### BRIEF DESCRIPTION OF THE DRAWINGS

Preferred embodiments of the present invention will now be described, by way of example only, with reference to the accompanying drawings, in which:

FIG. 1 is a block diagram of a data processing system;

FIG. 2 is a flow diagram of a write operation embodying the present invention;

FIG. 3 is a flow diagram of a read operation embodying the present invention; and,

FIG. 4 is a flow diagram of an idling operation embodying the present invention.

### DETAILED DESCRIPTION OF THE PREFERRED EMBODIMENT

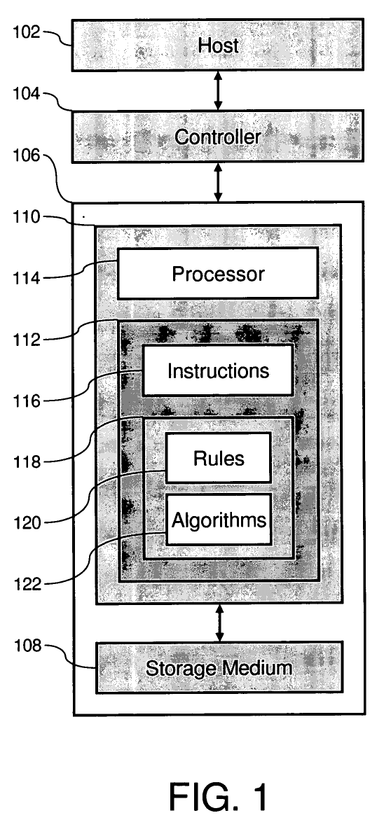

Referring first to FIG. 1, in a preferred embodiment of the present invention, there is provided a data processing system comprising a host computer 102. The host 102 is attached to a storage device controller 104. The controller 104 is in turn attached to a storage device 106 for storing user data operated on by the host 102.

The storage device 106 comprises a storage medium 108 in the form of a magnetic data storage disk. In other embodiments of the present invention, the medium 108 may be of different form, such as an optical storage disk, for example. User data is written to the medium 108 via a Write command. Similarly, data is read from the medium 108 via a Read command. The Read and Write commands are hereinafter collectively referred to as Input/Output (I/O) commands.

The storage medium 108 is formatted during an initialisation routine in preparation for storage of user data. The formatting includes partitioning of the medium 108 into blocks or logical block addresses (LBAs). Each LBA includes a portion for storage of data and a portion for storage of error checking and correction (ECC) codes associated with the data. A pattern defines how each LBA is filled with data and ECC codes. The size of the LBAs is defined when the storage medium 108 is formatted. This process is known as surface initialisation. In a preferred embodiment of the present invention, the surface initialisation is performed by the storage device 106 in response to an initialisation command supplied from the controller 104.

The storage device 106 comprises control logic 110 for controlling transducers such as data read/write heads in response to the aforementioned I/O commands. The control logic 110 comprises a processor 114 and non-volatile storage 112 connected to the processor 114. The non-volatile storage 112 may be implemented by, for example, non-volatile random access memory (NVRAM) technology. Alternatively, the non-volatile storage 112 may be on the storage medium 108. Instructions 116 and data 118 are recorded in the non-volatile storage 112.

In operation, the processor 114 executes the instructions 116 to control the storage device 106. The processor 114 may be dedicated to executing the instructions 116. Alternatively, the processor 114 may be of general purpose additionally performing other tasks. The processor 114 may be implemented in hardwired logic. Alternatively, the processor 114 may be implemented by a combination of hardwired logic and program code, such as a programmable logic array operable under replaceable logic settings. Such logic settings may be embodied in, for example, a hardware description language.

The data 118 comprises an integrity checking algorithm 122 and corresponding rules 120. The algorithm 122 effectively defines a pattern. Specifically, the algorithm 122 is executable by the processor 114 to generate the ECC codes for each LBA based on data to be placed therein and to verify the integrity of data in the each LBA based on the ECC codes therein.

The rules 120 determine when the algorithm 122 is invoked. The rules 120 may be data dependent, time dependent or both. For example, the determination may be based on a schedule, or a state of the storage device 106 such as a reading state, a writing state, or an idle state. The rules 120 may indicate that the algorithm 122 is to be invoked when I/O commands to particular LBAs are issued. Similarly, the rules 120 may indicate that the algorithm 122 is to be invoked the current rate of I/O traffic is above or below a preset threshold. Likewise, the rules 120 may indicate that the algorithm 122 is to be invoked at defined intervals. The storage device 106 may have a clock or receive associated timing signals from an external source. Equally, the rules 120 may indicate that the algorithm 122 is to be invoked for Write operations involving user data above or below a certain threshold size. It will be appreciated that many other rules 120 are possible. It will be equally appreciated that different applications may demand different combinations of rules 120.

In a preferred embodiment of the present invention, the algorithm 112 and rules 120 are downloaded to the storage device 106 from the controller 104 and stored in the non-volatile storage 112. The algorithm 122 and rules 120 allow the storage device 106 to self check data integrity in different circumstances. The storage device 106 can thus perform error checking and initiate error recovery autonomically in response to events or combinations of events occurring within the storage device 106. The algorithm 122 may involve LRC checking, ECC checking, or CRC checking. It will be appreciated that other algorithms are equally possible.

In a preferred embodiment of the present invention, the algorithm 122 and rules 120 are delivered in a package sent to the storage device 106 from the controller 104. The package may be initially delivered with the aforementioned initialisation command. Updated packages may be thereafter sent by the controller 104 in response to a command from the host computer 102. The command may be issued at any time. Thus, self checking of the storage device 106 can be changed dynamically.

Syntax checking may be performed on the package to check that no errors were introduced to corrupt the contents thereof. Such syntax checking may be implemented in stages at both the controller 104 and the storage device 106.

The controller 104 may have a clock function for periodically sending new packages to the storage device 106. For example, at 0900, the controller 104 may send the device 106 a package in which rules 120 based on I/O rate are removed. Then, at 1700, the controller 104 may send the storage device 106 a package in which the rules 120 based on I/O rate are replaced. It will be appreciated that, other embodiments of the present invention, different techniques may be employed for supplying the rules 120 and algorithm 122 from the controller 104 to the storage device 106. Equally, it will be appreciated that the behaviour of the storage device 106 on detection of an error may be governed by the algorithm 122 supplied by the controller 104. Accordingly, such behaviour can be defined and redefined by updating the algorithm 122 stored in the storage device 106. Thus, the response of the storage device 106 to a given stimulus can be tuned. It may be desirable for the device 106 to automatically check that the rules 120 and algorithm 122 are still valid after some or all of the system is reset. The algorithm 122 sent to the storage device 106 may indicate how to initialise the LBAs.

In a preferred embodiment of the present invention, the controller 106 assigns to each LBA a binary value: “clean” or “dirty”. The binary value may be implemented by a single binary bit. Accordingly, “clean” may be implemented by one of binary “0” or “1” and “dirty may be implemented by the other of binary “0” or “1”. The value may be stored in the non-volatile storage 112. Alternatively, the value may be stored on the medium 108. In the latter case, the value may be kept in an ID block preceding each LBA. Each LBA to which data has been written is deemed clean. All other LBAs are deemed dirty. A read operation from a clean LBA returns data recorded on the medium 108. A read operation from a dirty LBA returns data generated by the controller 106 based on the algorithm 122.

In a particularly preferred embodiment of the present invention, the aforementioned initialization command sent to the storage device 106 from the controller 104 marks all LBAs as dirty. No other I/O activity takes place. The storage device 106 can then more rapidly return a completion status to the controller 104 than possible in conventional systems. Advantageously, storage is made available for use more quickly than in conventional systems, in which formatting operations write a data pattern to every LBA on the medium 108. As indicated earlier, a read operation from a dirty LBA returns data generated by the control logic 110 based on the algorithm 122. The return can thus be made more quickly than possible when having to access the storage disk 108. This leads to better performance when, for example, rebuilding an array of storage devices such as a RAID array. The initialization command may not require the medium 108 to be formatted, provided that there is storage space allocated in the storage device 106 for recording the binary value assigned to each LBA.

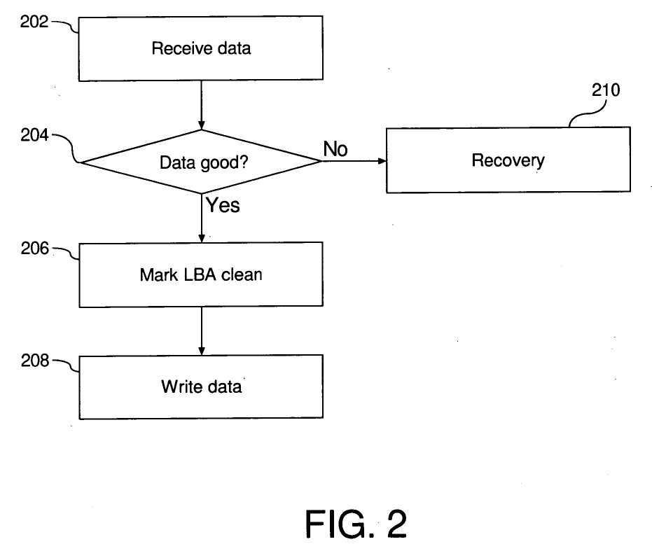

When data is written to a LBA, the storage device 106 marks the LBA as clean. This has negligible impact on write time and hence does not impair performance of the storage device 106. A write operation will now be described with reference to FIG. 2. At step 202, data to be written to the medium 108 is received by the storage device 106. At step 204, the storage device 106 checks the received data based on the algorithm 122. If the algorithm 122 indicates that the data is good, then, at step 206, the storage device 106 marks the LBA into which the data is to be written as clean. Thereafter, at step 208, the storage device 106 writes the data to the LBA, together with corresponding ECC codes generated by the algorithm 122. If, at step 204, the algorithm 122 finds that the data is incorrect or corrupt then, at step 210, the storage device 106 may attempt error recovery processing. Such processing may return an error to the controller 104, or provide other similar error processing actions, depending on the algorithm 122.

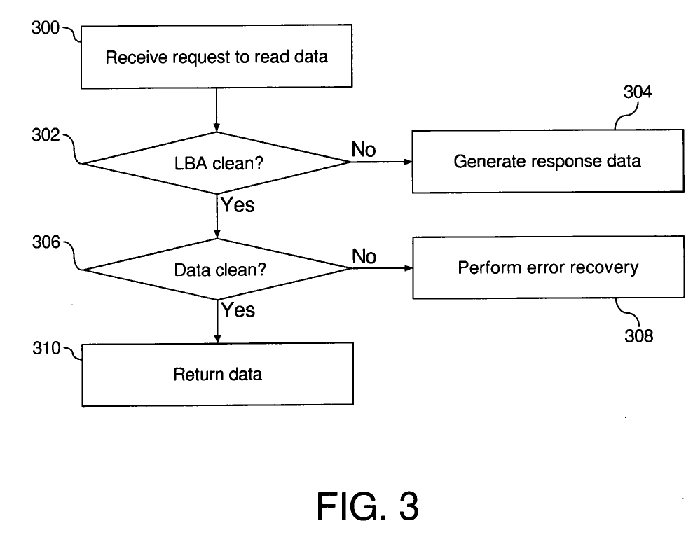

On receipt of a request to read data from a LBA, the storage device 106 determines if the LBA is clean or dirty before the LBA is read. The determination may be performed without accessing the storage medium 108 if the binary value assigned to the LBA is stored remotely. As indicated earlier, the binary value may be recorded in the non-volatile storage 112. If the LBA is dirty, a response generated by the algorithm 122 is returned to the controller 104. This ensures that good data is returned. A read operation from a dirty LBA does not require error recovery by the storage device 106. If the LBA is clean, data is read from the medium 108. The data read is then processed as normal. A read operation will now be described in detail with reference to FIG. 3. At step 300, the storage device 106 receives a request to read data from an LBA on the medium 108. At step 302, the storage device 106 determines if the LBA is marked clean or dirty. If the LBA is marked dirty, then, at step 304, the device 106 generates response data using the algorithm 122 and sends the response data back to the controller 104 by way of response to the read request. If the LBA is marked clean, then, at step 306, the device 106 reads the data from the specified LBA and checks the data read using the algorithm 122. If the algorithm 122 indicates that the data read is good, then, at step 308, the storage device 106 returns the data read to the controller 104 by way of response to the read request. If the algorithm 122 indicates that the data is corrupt, then, at step 310, the storage device 106 may perform error recovery processing as herein before described.

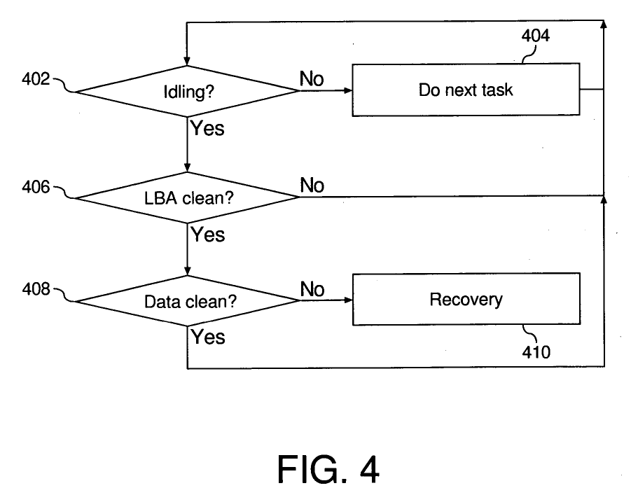

The storage device 106 also checks the validity of the LBAs on the medium 108 when idling. If a dirty LBA is found, the storage device 106 continues to the next LBA. Operation of the device 106 when idling will now be described in detail with reference to FIG. 4. At step 402, the device 106 determines if it is idling. If the storage device 106 determines that it is not idling, then, at step 404, the device 106 performs its next task. If the device 106 determines that it is idling then, at step 406, the device 106 determines if the next LBA on the medium 108 is marked clean or dirty. If the next LBA is marked dirty, then the device 106 returns to the idling test at step 402. If the next LBA is marked clean, then, at step 408, the device 106 performs a check on the data using the algorithm 122. If the algorithm 122 indicates that the data is good, then the device 106 returns to the idling test at step 402. If the algorithm 122 indicates that the data is corrupt, then, at step 410, may perform error recovery processing as herein before described. The device 106 may take a user-defined action. For example, the device 106 may request the host 102 to reject the LBA. The device 106 may save an error indication to be sent to the controller 104 in response to the next relevant I/O command received.

Embodiments of the present invention may be compatible with the Small Computer Serial Interface (SCSI). Such embodiments may involve an amendment to the SCSI specification. The amendment may specify a new SCSI command to transfer the package containing the algorithm 122 and rules 120 to the device 106. The device 106 may be adapted to list the algorithm 122 stored therein in response to an SCSI inquiry. In other embodiments of the present invention, different communication protocols may be adapted. Other embodiments of the present invention may employ, for example, vendor unique option fields in a communication protocol for passing the algorithm 122 and rules 120 from the controller 104 to the device 106.

The data 118 may comprise plural checking algorithms 122 each corresponding. The rules 120 determine the type of algorithms 122 to be performed depending on circumstances.

### Advantages Over the Prior Art

A data processing system having a host computer and a storage device connected to the host via a storage controller, wherein integrity checking algorithms, together with rules determining when such algorithms are invoked, are downloaded from the controller to the storage device. The storage device then operates autonomically based on the rules. Further instruction or input from the user is not required. Integrity checking functions can be selectively enabled, disabled, or otherwise adapted during normal operation of the system. Specifically, the system need not be powered down or otherwise reset to permit such modifications. Responses to errors found can be defined according to circumstances in which they occur. The present invention is applicable to different kinds of storage media. In preferred embodiments of the present invention, the device 106 comprises firmware, hardware, logic, circuitry, or a combination thereof, for executing the algorithm 122 based on the rules 120. Similarly, the present invention is applicable to different kinds of data formatting pattern. The storage device comprises logic for generating data to return to the storage controller in response to a request to access an unaltered LBA. Thus, the storage medium need not be accessed in response to such requests. Accordingly, the time needed to respond to such requests is reduced.

### Alternative Embodiments

It will be appreciated that, although specific embodiments of the invention have been described herein for purposes of illustration, various modifications may be made without departing from the spirit and scope of the invention. In particular, the present invention may be at least partially implemented in software running on one or more processors. Such software may be provided as a computer program element carried on any suitable data carrier such as a magnetic or optical computer disk. It will likewise be appreciated that the present invention may be at least partially embodied in a computer program product for use in a computer system. Such an implementation may comprise computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. It will be also appreciated that such computer readable instructions can be written in a number of programming languages for use with many different computer architectures or operating systems. Further, such instructions may be stored using any memory technology, including but not limited to, semiconductor, magnetic, or optical, or transmitted using any communications technology, including but not limited to optical, infrared, or microwave. Such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web. Accordingly, the scope of protection of this invention is limited only by the following claims and their equivalents.

We claim:

1. A method for operating a data storage device having a data storage medium partitioned into blocks, comprising:
assigning a binary value to each block;
setting an initial binary value of each block to a first level;
setting said binary value to a second level in response to each block in receipt of written data; and
in response to a request from a host to read data from a block,
checking said binary value assigned to said block;
generating read data from said block if said binary value is set to said second level;
generating response data if said binary value of said block is set to said first level; and
sending data to said host, wherein said data is selected from a group consisting of: read data and response data.

2. The method of claim 1, further comprising reviewing data for errors prior to sending data to said host.

3. The method of claim 2, further comprising performing error recovery on said data in response to detection of an error.

4. The method of claim 1, further comprising checking said binary value assigned to each successive block address in response to detection that said storage device is operating in an idle state.

5. The method of claim 4, wherein the step of checking said binary value includes reviewing data stored in said block address for error and performing error recovery on data in response to an error detection for each block having an assigned binary set to said second level.

6. The method of claim 1, wherein the step of generating response data includes use of an algorithm.

7. A data storage device comprising:
a data storage medium partitioned into blocks;
logic adapted to assign a binary value to each block, wherein each binary value is initially set to a first level;
said binary value assigned to each block into which data is written is adapted to be set to a second level;
a first algorithm adapted to respond to a request from a host to read data from a block, said algorithm comprising:
a check of said binary value assigned to said block;
read data adapted to be generated from said block responsive to said binary being set to said second level;
response data adapted to be generated responsive to said binary being set to said first level; and
said data adapted to be sent to a host, wherein said data is selected from a group consisting of: read data and response data.

8. The device of claim 7, wherein said response data is adapted to be generated through use of a second algorithm.

9. The device of claim 7, wherein said logic is adapted to review data read from said block prior to receipt of said data by said host.

10. The device of claim 9, further comprising performance of error recovery on said data in response to detection of an error.

11. The device of claim 7, further comprising a review of said binary value assigned to each successive block address responsive to detection of operation of said storage device in an idle state.

12. The device of claim 11, wherein said review includes a check of data stored in said block address for error and performance of error recovery on data responsive to an error detection for each block assigned a binary set to said second level.

13. A computer program product comprising:
a computer useable medium embodying computer usable program code for operating a data storage medium partitioned into blocks, said computer program product including:
computer useable program code for assigning a binary value to each block, with an initial binary value of each block set to a first level, and said binary value set to second level responsive to receipt of written data; and
computer useable program code for responding to a request from a host to read data from said block, said code comprising:
instructions for checking said binary value assigned to said block;
instructions for generating read data from said block if said binary value is set to said second level;
instructions for generating response data if said binary value of said block is set to said first level; and
instructions for sending data to said host, wherein said data is selected from a group consisting of: read data and response data.

14. The computer program product of claim 13, wherein said instructions for generating response data executes an algorithm

15. The computer program product of claim 13, wherein said computer usable program code for assigning a binary value to each block reviews data for error prior to sending said data to said host.

16. The computer program product of claim 15, further comprising computer useable program code for performing error recovery on said data in response to detection of an error.

17. The computer program product of claim 13, further comprising computer useable code for detecting operation of said storage device in an idle state and reviewing said binary value of each successive block address responsive to said detection.

18. The computer program product of claim 17, wherein said code for detecting operation of said storage device includes computer useable code to review data in said block address for error and to perform error recovery on data with a detected error for each block having a binary set to said second level.

19. The computer program product of claim 13, wherein said code for responding to a request from a host to read data from said block is responsive to a rule selected from a group consisting of: data dependent and time dependent.

20. A method for operating a data storage device having a data storage medium partitioned into blocks, comprising:
assigning a binary value to each block;
setting an initial binary value of each block to a first level;
setting said binary value to a second level in response to each block in receipt of written data; and
in response to a request from a host to read data from a block,
checking said binary value assigned to said block;
generating read data from said block if said binary value is set to said second level;
executing an algorithm to generate response data if said binary value of said block is set to said first level; and
sending data to said host, wherein said data is selected from a group consisting of: read data and response data.
